(19) United States
(12) Patent Application Publication
(10) Pub. No.: US 2024/0026725 A1
(43) Pub. Date: Jan. 25, 2024

(54) System for Hollow Metal Frame Installation

(71) Applicant: Michael David Strickland, Ranch Cucamonga, CA (US)

(72) Inventor: Michael David Strickland, Ranch Cucamonga, CA (US)

(21) Appl. No.: 17/868,412

(22) Filed: Jul. 19, 2022

(51) Int. Cl. E06B 1/60; E06B 1/16

(52) U.S. Cl. CPC E06B 1/6076; E06B 1/16

(57) ABSTRACT

A system for hollow metal frame installation comprising at least one retaining shim, a head leveler, at least one cross string clip, a plumb bob clip, and a HMF spreader. The at least one retaining shim is configured to shim an HMF to desired wall finish thickness. The head leveler is configured to raise the HMF to be level. The at least one cross string clip is configured to measure alignment of the HMF. The plumb bob clip is configured to measure the plumbness of the HMF. The HMF spreader is configured correct deficiencies in the opening size of the HMF.

### FIELD OF THE INVENTION

The present invention relates generally to frame installation, and more specifically to tools for the installation of hollow metal frames.

### BACKGROUND OF THE INVENTION

Hollow metal frames (HMF) are regularly installed in buildings that require greater durability and security. Various types of doors can be installed in hollow metal frames as well as windows or openings. These frames generally anchor directly to the surrounding wall studs.

A HMF generally consists of a head, a hinge jamb, and a strike jamb. Installation of an HMF requires each of these components being secured to the surrounding wall. To properly install an HMF, care must be taken to ensure that each of the components are level/plumb so a door can correctly fit and operate within the HMF.

Various tools exist for properly fitting and levelling a HMF during installation. However, these tools are often large and bulky, having support legs and cross beams. Bulky tools such as these make both transport and use of the tools more difficult. Further, many current options for aid in HMF installation are created specifically for use with masonry walls and do not function with metal or wood studs.

Thus, there is a need for a system that can aid in support and leveling of a HMF during installation into wood or metal stud walls without the use of large or bulky apparatuses.

### SUMMARY OF THE INVENTION

The present invention is a system for hollow metal frame installation comprising at least one retaining shim, a head leveler, at least one cross string clip, a plumb bob clip, and a HMF spreader. The at least one retaining shim comprises a shim base, a jamb stop, at least one shim plate, a retainer clip, a strike plate, and a retaining screw and is configured to shim an HMF to desired wall finish thickness. The head leveler comprises a leveler base, a pivot foot, and an adjustment screw and is configured to raise the HMF to be level. The at least one cross string clip comprises a cross string base, a frame stop, a string post, and a magnet and is configured to measure alignment of the HMF. The plumb bob clip comprises a plumb base, a first frame clip with a first slot, and a second frame clip with a second slot and is configured to measure the plumbness of the HMF. The HMF spreader comprises a spreader base and a travel head and is configured to correct deficiencies in the opening size of the HMF.

### BRIEF DESCRIPTION OF THE DRAWINGS

FIG. 1 is a top front isometric view of the retaining shim of the present invention in accordance with at least one embodiment.

FIG. 2 is a bottom rear isometric view of the retaining shim of the present invention in accordance with at least one embodiment.

FIG. 3 is a top front isometric view of the head leveler of the present invention in a non-engaged configuration in accordance with at least one embodiment.

FIG. 4 is a bottom rear isometric view of the head leveler of the present invention in a non-engaged configuration in accordance with at least one embodiment.

FIG. 5 is a left side elevation view of the head leveler of the present invention in an engaged configuration in accordance with at least one embodiment.

FIG. 6 is a top front isometric view of the cross string clip of the present invention in accordance with at least one embodiment.

FIG. 7 is a bottom rear isometric view of the cross string clip of the present invention in accordance with at least one embodiment.

FIG. 8 is a top front isometric view of the plumb bob clip of the present invention in accordance with at least one embodiment.

FIG. 9 is a bottom rear isometric view of the plumb bob clip of the present invention in accordance with at least one embodiment.

FIG. 10 is a top front isometric view of the HMF spreader of the present invention in accordance with at least one embodiment.

FIG. 11 is a bottom rear isometric view of the HMF spreader of the present invention in accordance with at least one embodiment.

### DETAIL DESCRIPTIONS OF THE INVENTION

All illustrations of the drawings are for the purpose of describing selected versions of the present invention and are not intended to limit the scope of the present invention.

The present invention is a system for hollow metal frame installation. The system of the present invention comprises at least one retaining shim 1, a head leveler 2, at least one cross string clip 3, a plumb bob clip 4, and an HMF spreader 5. The at least one retaining shim 1 is configured to shim an HMF to fit any wall finish thickness and hold the HMF in place during installation. The head leveler 2 is configured to raise the HMF to be level. The at least one cross string clip 3 is configured to hold cross strings for determining HMF alignment. The plumb bob clip 4 is configured to hold a plumb bob on the HMF for determining plumbness. The HMF spreader 5 is configured to spread the base and/or distance between jambs of the HMF as necessary to correct deficiencies.

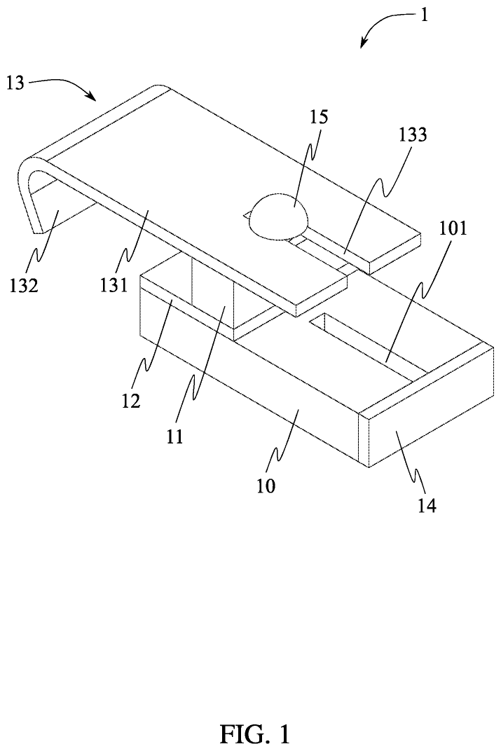

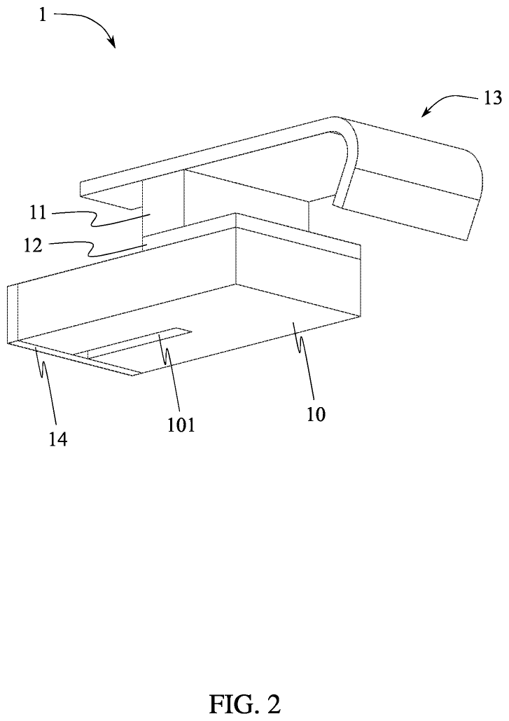

Referring to FIG. 1-2, the at least one retaining shim 1 of the present invention comprises a shim base 10, a jamb stop 11, at least one shim plate 12, a retainer clip 13, a strike plate 14, and a retaining screw 15. The shim base 10 of the at least one retaining shim 1 may further comprise an attachment slot 101 configured to accept an attachment screw, allowing the shim base 10 to be attached to a surface. The attachment slot 101 runs along the length of the shim base 10, allowing the attachment screw to be placed and moved along multiple points of the shim base's 10 length. The at least one shim plate 12 attaches to the shim base 10, the jamb stop 11 attaches to the at least one shim plate 12 opposite the shim base 10, and the retainer clip 13 attaches to the jamb stop 11 opposite the at least one shim plate 12. A channel (or retaining screw hole) runs through the shim base 10, at least one shim plate 12, and jamb stop 11, which the retaining screw 15 traverses. The retaining screw holds the shim base 10, at least one shim plate 12, and jamb stop 11 together, though additional screws or other attachments may also be used between these components to further secure the components and prevent unwanted rotation between components. The retainer clip 13 further comprises a retainer slot 133, a flat portion 131, and a curved portion 132. The retainer slot 133 connects to the retaining screw 15, allowing the retainer clip 13 to adjust along the slot relative to the channel and the retaining screw 15. In use, the curved portion 132 of the retainer clip 13 is oriented away from the shim base 10 of the retaining shim 1. The strike plate 14 is attached to the shim base 10, enclosing the attachment slot 101. The strike plate 14 is configured to be struck by a hammer or other tool for adjusting the retaining shim's 1 position relative to a screw, along the attachment slot 101. The at least one shim plate 12 is configured to provide a set distance at which the retaining shim 1 may hold the HMF to account for the thickness of wall finish. In the preferred embodiment, one shim plate 12 of a thickness of ⅛ inch is used, though more shim plates 12 may be added to the a retaining shim 1 and may be of any desired thickness.

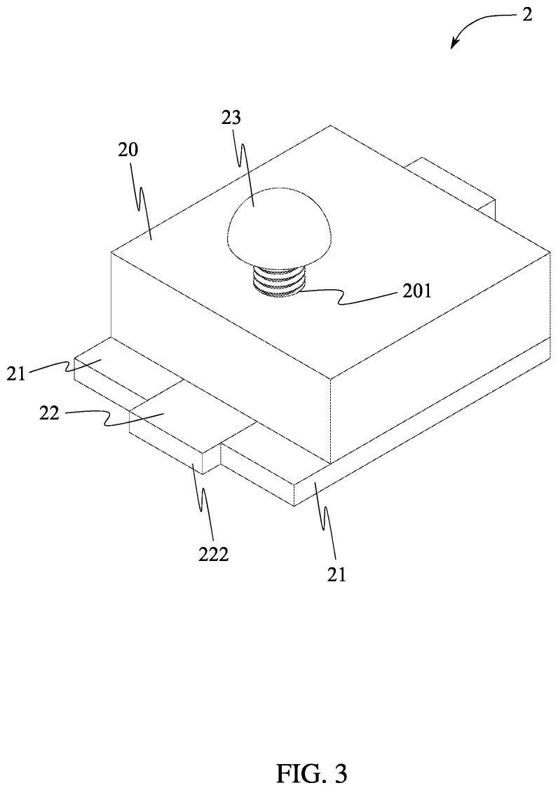

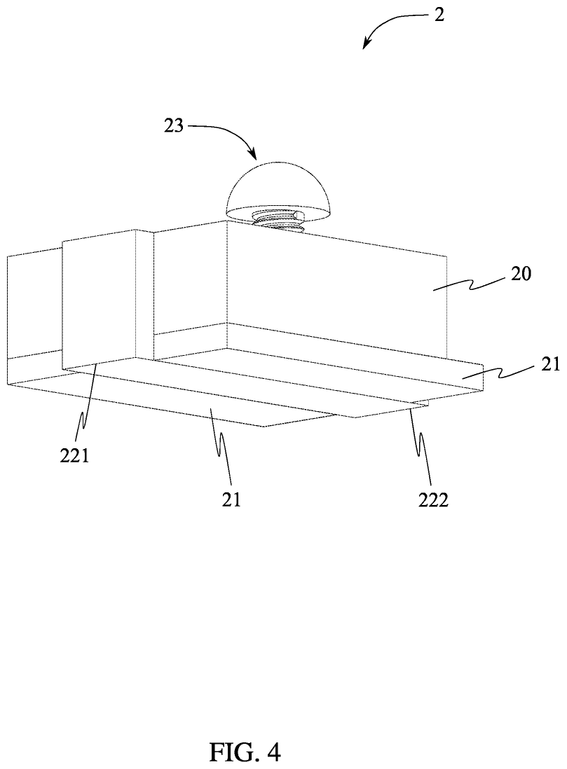

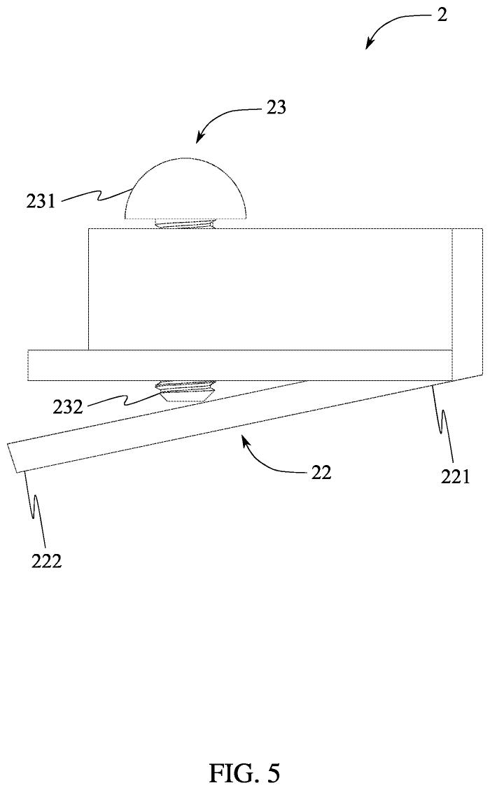

Referring to FIG. 3-5, the head leveler 2 of the present invention comprises a leveler base, at least one static foot 21, a pivot foot 22, and an adjustment screw 23. The leveler base 20 may further comprise a threaded adjustment hole 201 through which the adjustment screw 23 may be placed. In the preferred embodiment, a fixed end 221 of the pivot foot 22 is attached to the leveler base 20 and a free end 222 of the pivot foot 22 is positioned adjacent to the adjustment hole 201. The at least one static foot 21 may be positioned on the same side of the leveler base 20 as the pivot foot 22 to cover the entire face of the leveler base. The adjustment screw 23 is placed in the adjustment hole 201 with a tip 232 of the adjustment screw 23 positioned against the free end 222 of the pivot foot 22 and a head of the adjustment screw 23 opposite the body from the pivot foot 22. The adjustment screw 23 may be rotated to press against the pivot foot 22. The adjustment screw 23 is configured to push the free end 222 of the pivot foot 22 away from the leveler base 20 when tightened. The pivot foot 22 is configured to recoil to a position flush with the leveler base 20 when not being acted on by the adjustment screw 23. This configuration allows the head leveler 2 to raise portions of the HMF by positioning the head leveler 2 under/between the HMF and turning the adjustment screw 23 to expand the head leveler 2.

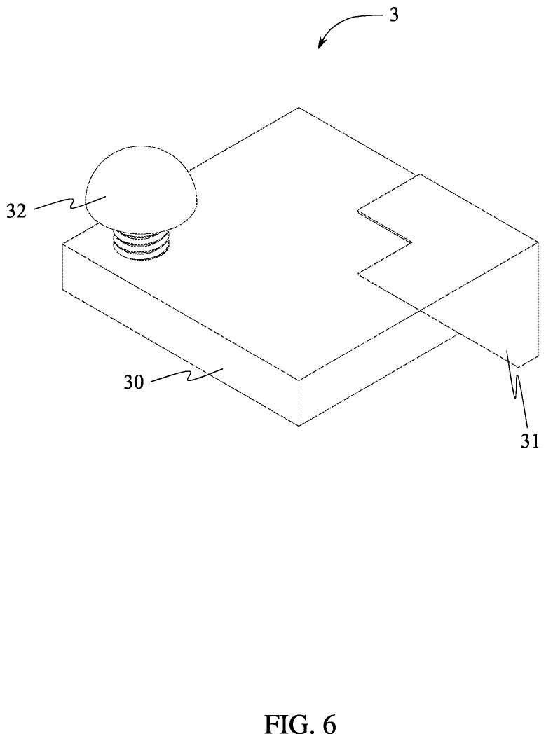

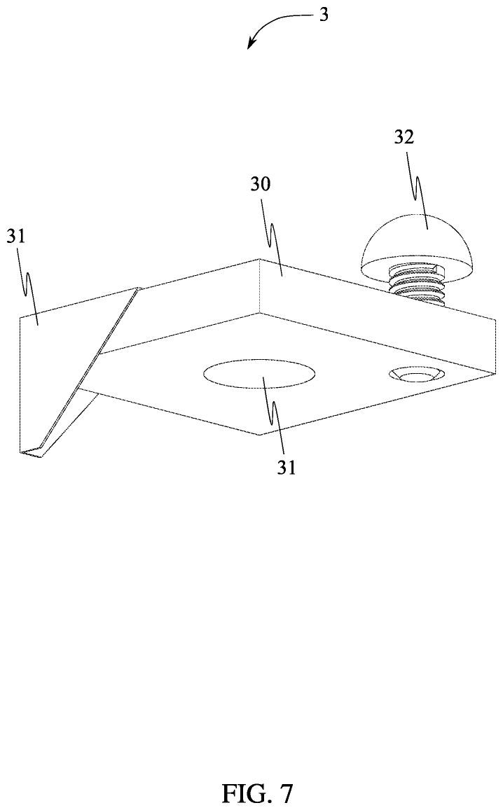

Referring to FIG. 6-7, the cross string clip 3 of the present invention comprises a cross string base 30, a frame stop 31, a string post 32, and a magnet 33. The cross string base 30 of the cross string clip 3 is substantially square with the frame stop 31 positioned at one corner of the cross string base 30 and the string post 32 positioned at the opposite corner. The frame stop 31 is shaped to rest against the corner of a HMF, configured to accept the shape of a corner of a rectangular prism. The magnet 33 may be positioned at any point within the cross string base 30, configured to secure the cross string base 30 to the HMF. In the preferred embodiment, the string post 32 is a threaded rod with a wing nut, the threaded rod extending out of the cross string base 30, with the wing nut adjustably attached to the threaded rod. The string post 32 is configured to accept and secure a string, generally by wrapping the string around the string post 32 and tightening the wing nut or other tightening mechanism of the string post 32.

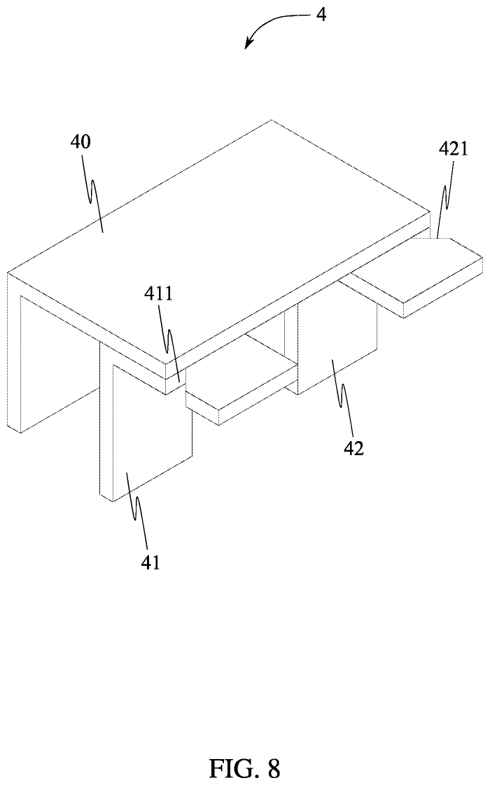

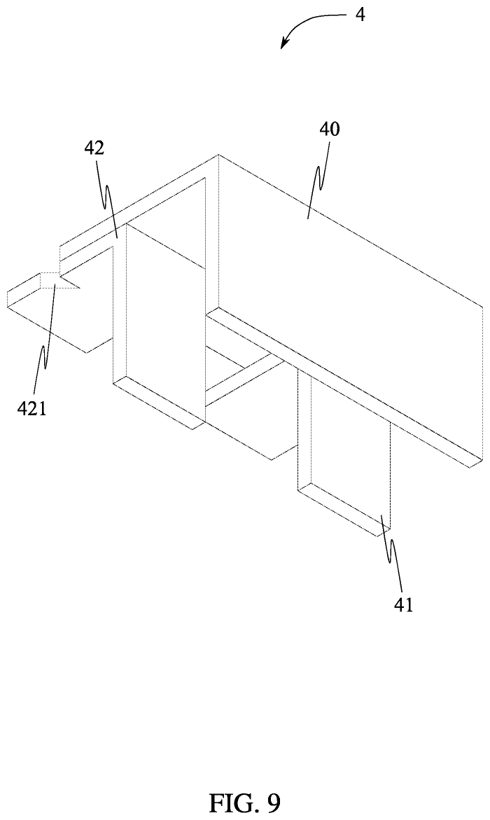

Referring to FIG. 8-9, the plumb bob clip 4 of the present invention comprises a plumb base 40, a first frame clip 41 with a first slot 411, and a second frame clip 42 with a second slot 421. The plumb bob clip 4 is configured to rest atop a HMF with the first slot 411 and second slot 421 extending parallel with the HMF head. The first slot 411 and the second slot 421 are configured to hold a string in place, such as that on a plumb bob. In the preferred embodiment, the plumb base 40, the first frame clip 41, and the second frame clip 42 are all substantially L-shaped. The first frame clip 41 and the second frame clip 42 are positioned opposite each other on the plumb base 40, creating a channel between the plumb base 40 and the frame clips on which the plumb bob clip 4 can rest on the HMF. The portions of the first frame clip 41 and the second frame clip 42 that extend away from the channel are where the first slot 411 and the second slot 421 are located. The plumb bob clip 4 is configured to be used with any plumb bob with or without a reel box.

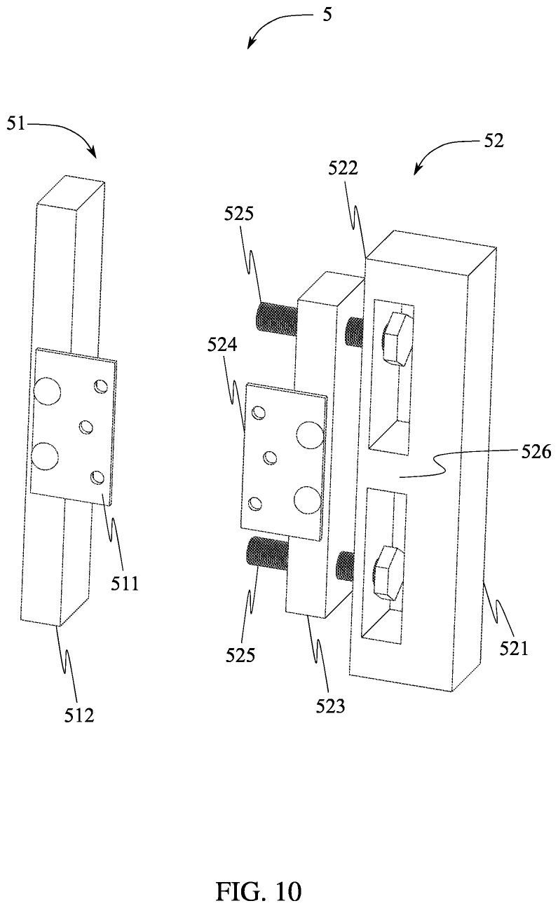

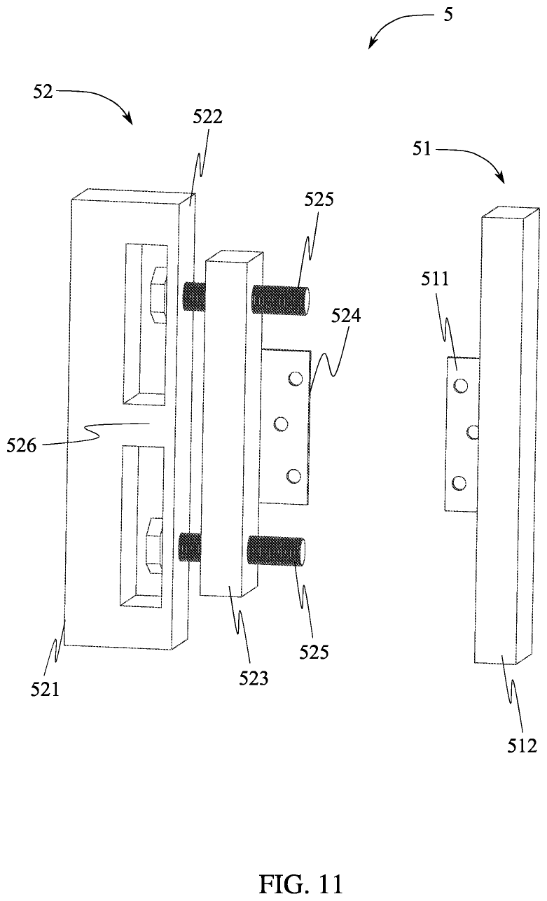

Referring to FIG. 10-11, the HFM spreader of the present invention comprises a spreader base 51 and a travel head 52. The spreader base 51 further comprises a base plate 512 and a first attachment plate 511. The first attachment plate 511 is attached to the base plate 512 and configured to attach to a stud. The travel head 52 further comprises a push plate 521, a stop plate 522, a threaded base 523, a second attachment plate 524, at least one bolt 525, and a spacer 526. The spacer 526 is placed between the push plate 521 and the stop plate 522, creating a gap. The stop plate 522 is adjustably attached to the threaded base 523 by the at least one bolt 525. The at least one bolt 525 is configured to be turned, adjusting the distance between the stop plate 522 and the threaded base 523. The second attachment plate 524 is attached to the threaded base 523 and configured to attach to a stud. A stud may be placed between the spreader base 51 and the travel head 52 by attaching one end of the stud to the first attachment plate 511 and attaching the opposite end of the stud to the second attachment plate 524. The entire length of the spreader base 51, stud, and travel head 52 may then be adjusted by turning the at least one bolt 525 to expand or retract the distance between the stop plate 522 and the threaded base 523.

The system for HMF installation of the present invention is used to correct issues with wall framing to head off installation issues down the line. Specifically, the present invention is designed to aid in avoiding issues with bottom runner alignment, wall plumbness, and wall opening size.

The first step in using the present invention for aiding in HMF installation is adjusting the at least one retaining shim 1 to the desired wall finish thickness. The plurality of shim plates 12 can be added or removed to/from each of the at least one retaining shim 1 to reach the desired thickness. Generally, four total retaining shims 1 will be used with one retaining shim 1 in each corner of the HMF. Frame lines may be marked to indicate the position of the HMF within the wall opening. Retaining shim 1 set up marks may then be made equal to the width of the HMF face, set back from the frame lines. The bottom of the shim base 10 of the retaining shims 1 may be screwed into the studs through the attachment slot 101 in the shim base 10 of the retaining shims 1, aligning the retaining shim set up marks with the connection point between the shim plate 12 and the jamb stop 11. For the retaining shim is positioned near the bottom of the HMF, they may be raised off the ground before securing by approximately ¼ inch as not to interfere if the HMF is later raised for levelling. In securing the retaining shims 1, the screw should not be fully tightened as to allow for the retaining shims 1 to be adjusted horizontally as needed. The retainer clips 13 may be removed from the retaining shims 1 before attaching them to the studs in order to facilitate easier attachment. The four retaining shims 1 are first used at the base of the HMF as described above. After securing the HMF to the floor, the same four retaining shims 1 can be installed near the head of the HMF so the same process can be conducted for fixing the head of the HMF.

Once the retaining shims 1 are in place, the HMF can be placed in the wall opening, over the retaining shims 1 and pressed tight against the jamb stops 11 of the retaining shims 1. Once the HMF is pressed against the jamb stop 11s of each of the retaining shims 1, the retainer clips 13 may be reattached to the retaining shims 1 and firmly tightened to hold the HMF against the jamb stops 11 of each of the retaining shims 1.

Further, the head leveler 2 may be used to raise the HMF after placement of the retaining shims 1 if required. The head leveler 2 is wedged under the HMF jamb and the adjustment screw 23 is turned, pressing the pivot foot 22 away from the leveler base 20 and raising the HMF in the process. Due to the pivotability of the jamb stop 11 and retaining clip on the retaining shims 1, this raising of the HMF can be done with the retaining shims 1 in place.

Next, the plum bob clip is draped over the top of the HMF, preferably on the hinge side of the HMF. A plumb line is then draped over the plumb bob clip 4, inserted into the first slot 411 and the second slot 421 on the first frame clip 41 and the second frame clip 42. A distance from the HMF to the plumb bob line is then measured. If the plum bob hangs to indicate a lack of plumbness, the retaining shim is may be adjusted left and right to attain plumbness in the HMF. Once plumbness is achieved, the screws fixing the retaining shim 1s to the studs may be tightened to lock in the achieved plumbness.

The plurality of cross string clips 3 is then used to check the depth alignment of the HMF. In the preferred embodiment, four cross string clips 3 are used, with one being placed on each of the four outer corners of the HMF. The frame stop 31 of each cross string clip 3 is positioned against the corner of the HMF and the magnet 33 of each cross string clip 3 secures the cross string clip 3 to the HMF. Strings may then be attached to the string posts 32 of the cross string clips 3 so that they diagonally cross the HMF. In the preferred embodiment, a first string is attached from the string post 32 of the bottom left cross string clip 3 to the string post 32 of the top right cross string clip 3 and a second string is attached from the string post 32 of the bottom right cross string clip 3 to the string post 32 of the top left cross string clip 3. The crossing of the first string and the second string are observed to determine if the HMF is misaligned. The HMF is misaligned if there is no contact between the strings or strong contact between the strings. In the case of misalignment, the thickness of the retaining shims 1 at the top of the HMF may be increased or decreased to remedy the misalignment. In the case of the retaining shims 1 being adjusted to correct alignment, the plumb bob clip 4 should be used after alignment to ensure the HMF is still plumb following adjustment of the retaining shim 1s.

The HMF may then be secured to the studs in the manner required by the specific HMF being used and the wall to which it is being secured. Minor deficiencies may not be noticeable until a door is installed in an HMF. If minor deficiencies (⅛ inch or less) are found after installation, the HMF spreader 5 may be used to correct the deficiencies. To use the HMF spreader 5, a free stud is attached to the HMF spreader 5, with the first attachment plate 511 of the base plate 512 attaching to one end of the free stud and the second attachment plate 524 of the travel head 52 attaching to the opposite end of the free stud. The free stud should be approximately 3¼ inches short of the desired HMF width. The HMF spreader 5 and the free stud are placed in the opening between the side jambs of the HMF with the push plate 521 against one jamb and the base plate 512 against the other. The at least on bolt 525 of the HMF spreader 5 can then be tightened to spread the HMF. After spreading the HMF, additional screws may be necessary to keep the HMF in the new position without springing back after the HMF spreader 5 is removed.

Although the invention has been explained in relation to its preferred embodiment, it is to be understood that many other possible modifications and variations can be made without departing from the spirit and scope of the invention.

What is claimed is:

1. A system for hollow metal frame installation, comprising:
at least one retaining shim;
a head leveler;
the at least one retaining shim having a shim base, a jamb stop, at least one shim plate, and a retainer clip;
the at least one shim plate connecting to the retaining shim base, the jamb stop connecting to the at least one shim plate opposite the shim base, and the retainer clip connecting to the jamb stop opposite the at least one shim plate, wherein a retaining screw adjustably runs through the shim base, the at least one shim plate, the jamb stop, and the retainer clip;
the retainer clip being adjustably connected to the retaining screw and configured to hold a frame against the jamb stop;
the head leveler having a leveler base, a pivot foot, and an adjustment screw;
the pivot foot attached to the leveler base; and
the adjustment screw traversing the leveler base, configured to interact with the pivot foot and press one end of the pivot foot away from the leveler base.

2. The system for hollow metal frame installation of claim 1, further comprising:
the at least one retaining shim further comprising an attachment slot and a strike plate;
the attachment slot being an opening in the shim base, configured to accept a screw for adjustably attaching the base to a surface; and
the strike plate attaching to the shim base, enclosing the attachment slot.

3. The system for hollow metal frame installation of claim 1, further comprising:
the pivot foot of the head leveler comprising a fixed end and a free end;
the adjustment screw of the head leveler having a head and a tip;
the fixed end of the pivot foot being attached to the leveler base;
the adjustment screw being traversing the leveler base with the head opposite the pivot foot;
the free end of the pivot foot being arranged adjacent to the tip of the adjustment screw; and
the adjustment screw being configured to interact with the free end of the pivot foot and push the free end away from the leveler base as the adjustment screw is tightened.

4. The system for hollow metal frame installation of claim 1, further comprising:
at least one cross string clip;
the at least one cross string clip comprising a cross string base, a frame stop, a string post, and a magnet;
the frame stop being connected to the cross string base and configured to accept a the corner of a rectangular prism;
the string post being connected to the cross string base opposite the frame stop and configured to accept and secure a string; and
the magnet being connected to the cross string base and configured to attach the cross string base to a frame.

5. The system for hollow metal frame installation of claim 1, further comprising:
a plumb bob clip;
the plumb bob clip comprising a plumb base, a first frame clip, and a second frame clip;
the first frame clip and the second frame clip being connected to opposite ends of the plumb base, extending away from the plumb base;
the first frame clip having a first slot;
the second frame clip having a second slot;
the plumb base being configured to securely sit atop a frame; and
the first slot and the second slot being configured to collectively hold a string in place.

6. The system for hollow metal frame installation of claim 1, further comprising:
an HMF spreader;
the HMF spreader comprising a travel head and a spreader base;
the travel head being adjustable in length;
the travel head being configured to attach to a stud; and
the spreader base being configured to attach to a stud.

7. The system for hollow metal frame installation of claim 6, further comprising:
the spreader base of the HMF spreader further comprising a base plate and a first attachment plate;
the travel head of the HMF spreader further comprising a push plate, a stop plate, a spacer, a threaded base; a second attachment plate, and at least one bolt;
the first attachment plate being attached to the base plate and configured to attach to a stud;
the spacer being connected between the push plate and the stop plate;
the threaded base being adjustably connected to the stop plate by the at least one bolt; and
the second attachment plate being attached to the threaded base and configured to attach to a stud.

8. The system for hollow metal frame installation of claim 4, wherein the at least one retaining shim comprises four retaining shims and the at least one cross string clip comprises four cross string clips.

9. A system for hollow metal frame installation, comprising:
at least one retaining shim;
a head leveler;
at least one cross string clip;
a plumb bob clip;
a HMF spreader;
the at least one retaining shim having a shim base, a jamb stop, at least one shim plate, and a retainer clip;
the at least one shim plate connecting to the retaining shim base, the jamb stop connecting to the at least one shim plate opposite the shim base, and the retainer clip connecting to the jamb stop opposite the at least one shim plate, wherein a retaining screw adjustably runs through the shim base, the at least one shim plate, the jamb stop, and the retainer clip;
the retainer clip being adjustably connected to the retaining screw and configured to hold a frame against the jamb stop;
the head leveler having a leveler base, a pivot foot, and an adjustment screw;
the pivot foot attached to the leveler base;
the adjustment screw traversing the head leveler body, configured to interact with the pivot foot and press one end of the pivot foot away from the leveler base;
the at least one cross string clip comprising a cross string base, a frame stop, a string post, and a magnet;
the frame stop being connected to the cross string base and configured to accept a the corner of a rectangular prism;
the string post being connected to the cross string base opposite the frame stop and configured to accept and secure a string;
the magnet being connected to the cross string base and configured to attach the cross string base to a frame;
the plumb bob clip comprising a plumb base, a first frame clip, and a second frame clip;
the first frame clip and the second frame clip being connected to opposite ends of the plumb base, extending away from the base;
the first frame clip having a first slot;
the second frame clip having a second slot;
the plumb base being configured to securely sit atop a frame;
the first slot and the second slot being configured to collectively hold a string in place;
the HMF spreader comprising a travel head and a spreader base;
the travel head being adjustable in length;
the travel head being configured to attach to a stud; and
the spreader base being configured to attach to a stud.

10. The system for hollow metal frame installation of claim 9, further comprising:
the at least one retaining shim further comprising an attachment slot and a strike plate;
the attachment slot being an opening in the retaining shim base, configured to accept a screw for adjustably attaching the shim base to a surface; and
the strike plate attaching to the shim base, enclosing the attachment slot.

11. The system for hollow metal frame installation of claim 9, further comprising:
the pivot foot of the head leveler comprising a fixed end and a free end;
the adjustment screw of the head leveler having a head and a tip;
the fixed end of the pivot foot being attached to the leveler base;
the adjustment screw being traversing the base with the head opposite the pivot foot;
the free end of the pivot foot being arranged adjacent to the tip of the adjustment screw; and
the adjustment screw being configured to interact with the free end of the pivot foot, pushing the free end away from the leveler base as the adjustment screw is tightened.

12. The system for hollow metal frame installation of claim 9, further comprising:
the base of the HMF spreader further comprising a base plate and a first attachment plate;
the travel head of the HMF spreader further comprising a push plate, a stop plate, a spacer, a threaded base; a second attachment plate, and at least one bolt;
the first attachment plate being attached to the base plate and configured to attach to a stud;
the spacer being connected between the push plate and the stop plate;
the threaded base being adjustably connected to the stop plate by the at least one bolt; and
the second attachment plate being attached to the threaded base and configured to attach to a stud.

13. The system for hollow metal frame installation of claim 9, wherein the at least one retaining shim comprises four retaining shims and the at least one cross string clip comprises four cross string clips.
